(19) United States
(12) Patent Application Publication
(10) Pub. No.: US 2024/0255719 A1
(43) Pub. Date: Aug. 1, 2024

(54) OPTICAL FIBER CABLE HAVING ONE OR MORE CABLE COMPONENTS WITH LAYER-BY-LAYER FLAME RETARDANT COATING

(71) Applicant: CORNING RESEARCH & DEVELOPMENT CORPORATION, Corning, NY (US)

(72) Inventor: Jie Feng, Berlin (DE)

(21) Appl. No.: 18/635,500

(22) Filed: Apr. 15, 2024

Related U.S. Application Data
(63) Continuation of application No. PCT/US2022/049092, filed on Nov. 7, 2022.
(60) Provisional application No. 63/277,291, filed on Nov. 9, 2021.

(51) Int. Cl. G02B 6/44

(52) U.S. Cl. CPC G02B 6/4436; G02B 6/4434; G02B 6/4486

(57) ABSTRACT

Disclosed herein are embodiments of an optical fiber cable. The optical fiber cable includes a cable jacket having a jacket inner surface and a jacket outer surface in which the jacket inner surface defines a central bore extending along a longitudinal axis of the optical fiber cable. The optical fiber cable also includes a buffer tube having an inner buffer tube surface and an outer buffer tube surface, and the buffer tube is disposed within the central bore of the cable jacket. At least one optical fiber is disposed within the buffer tube. A flame retardant coating having at least one layer is applied to one or both of the jacket outer surface of the cable jacket or the outer buffer tube surface of the buffer tube.

### PRIORITY APPLICATION

This application is a continuation of International Patent Application No. PC7T/US20221049092, filed Nov. 7. 2022, which claims the benefit of priority of U.S. Provisional Application No. 63/277,291, filed on Nov. 9, 2021, the content of which is relied upon and incorporated herein by reference in its entirety.

### BACKGROUND

The present invention generally relates to an optical fiber cable and in particular to an optical fiber cable having one or more cable components having a flame retardant coating applied using layer-by-layer technology.

Optical fiber cables are often routed within buildings or to homes for distribution of information through optical signals. Because of the presence of the cables within such premises, it may be desirable to incorporate flame retardant polymeric materials in the cables to help prevent flame spread within the premises. However, flame retardant polymers generally include a significant amount of flame retardant filler materials, which can degrade the mechanical properties of the polymer. Further, to provide a sufficient amount of flame retardant material, the thickness of various cable components may have to be increased, increasing the thickness of the cable overall. Further, the components of some small diameter cables may not be able to incorporate enough filler because of size constraints to sufficiently boost the flame retardant performance.

### SUMMARY

According to an aspect, embodiments of the present disclosure relate to an optical fiber cable. In one or more embodiments, the optical fiber cable includes a cable jacket having a jacket inner surface and a jacket outer surface in which the jacket inner surface defines a central bore extending along a longitudinal axis of the optical fiber cable. In some such embodiments, the optical fiber cable also includes a buffer tube having an inner buffer tube surface and an outer buffer tube surface, and the buffer tube is disposed within the central bore of the cable jacket. Further, in embodiments, at least one optical fiber is disposed within the buffer tube. As will be described below, a flame retardant coating having at least one layer is applied to one or both of the jacket outer surface of the cable jacket or the outer buffer tube surface of the buffer tube.

According to another aspect, embodiments of the present disclosure relate to a method of applying a flame retardant coating to a polymeric component of an optical fiber cable. In one or more embodiments of the method, the polymeric component is extruded, and the polymeric component is sprayed with at least one coating sequence including a polycation spray, water, a polyanion spray, and water to form at least one layer of the flame retardant coating on an outer surface of the polymeric component.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims.

### BRIEF DESCRIPTION OF THE DRAWINGS

The accompanying drawings are included to provide a further understanding, and are incorporated in and constitute a part of this specification. The drawings illustrate one or more embodiment(s), and together with the description serve to explain principles and operation of the various embodiments. In the drawings:

FIG. 1 depicts an embodiment to an optical fiber cable comprising cable components that may be provided with a layer-by-layer flame retardant coating, according to an exemplary embodiment;

FIG. 2 depicts another embodiment of an optical fiber cable comprising cable components that may be provided with a layer-by-layer flame retardant coating, according to an exemplary embodiment;

FIG. 3 depicts detail view of a layer-by-layer flame retardant coating applied to a cable component, according to an exemplary embodiment; and

FIG. 4 depicts a system for applying the layer-by-layer flame retardant coating to the cable component, according to an exemplary embodiment.

### DETAILED DESCRIPTION

Referring generally to the figures, various embodiments of an optical fiber cable having one or more cable components with a flame retardant coating are disclosed. According to the present disclosure, the flame retardant coating is applied via a layer-by-layer (LBL) technique in which positively and negatively charged ionic solutions are alternatively sprayed onto an extruded cable component to form a plurality of layers. Conventionally, enhanced flame retardant performance for cable components was achieved by using polymers that were highly filled with flame retardant additives, such as magnesium hydroxide or alumina trihydrate. However, to achieve desired levels of flame retardance, the thickness of the polymer component had to be increased, which increased the size of the cable. Alternatively, the polymer had to be filled to such high levels that the mechanical properties degraded. In contrast, the LBL flame retardant coating is a thin coating that provides greatly enhanced flame retardant performance without degrading the mechanical properties of the cable. These and other aspects and advantages will be discussed in relation to the embodiments provided below and in the drawings. These embodiments are presented by way of illustration and not by way of limitation.

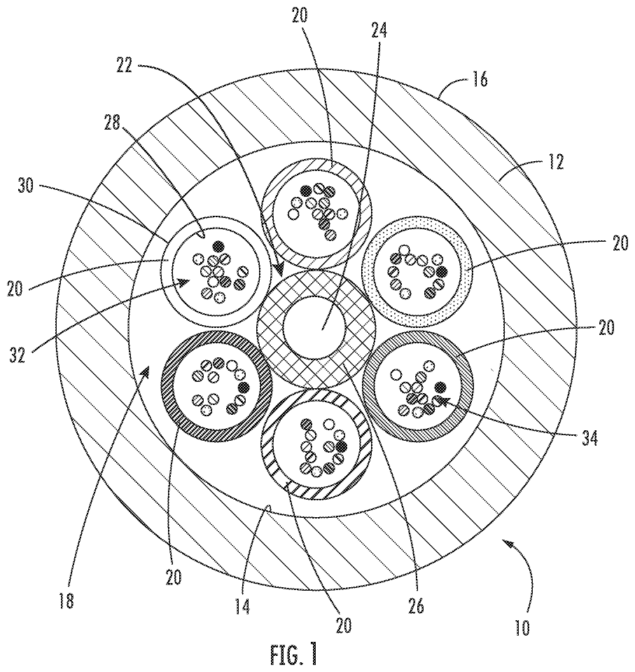

FIG. 1 depicts an embodiment of an optical fiber cable 10. The optical fiber cable 10 includes a cable jacket 12 having a jacket inner surface 14 and a jacket outer surface 16. In one or more embodiments, the jacket outer surface 16 defines an outermost surface of the optical fiber cable 10. However, in one or more embodiments as will be discussed below, the jacket outer surface 16 may be coated with a flame retardant coating in which case the flame retardant coating would be the outermost surface of the optical fiber cable 10. The jacket inner surface 14 defines a central bore 18 that extends along a longitudinal axis of the optical fiber cable 10.

In one or more embodiments, the cable jacket 12 is comprised of a flame retardant, non-corrosive (FRNC) material or a low smoke, zero halogen (LSZH) material. FRNC materials, in particular, do not include halogens, such as chlorine. Examples of such FRNC materials include a matrix polymer having a flame retardant additive dispersed therein. In one or more embodiments, the flame retardant additive is, for example, alumina trihydrate (ATH) or magnesium hydroxide (MDH). In some such embodiments, the flame retardant additive is included in amount of 30% to 60% by weight of the FRNC material with the polymer matrix and other typical polymer processing additives comprising the remainder. In one or more embodiments, the polymer matrix comprises a thermoplastic, and in one or more specific embodiments, the thermoplastic is a polyolefin-based polymer. Example polymers that may be used for the polymer matrix of the FRNC material include a single polymer or a blend of polymers selected from the following non-exhaustive list: ethylene-vinyl acetate copolymers, ethylene-acrylate copolymers, ethylene homopolymers (including but not limited to low density, medium density, and high density), linear low density polyethylene, very low density polyethylene, polyolefin elastomer copolymer, propylene homopolymer, polyethylene-polypropylene copolymer, butene- and octene branched copolymers, polyester copolymers, polyethylene terephthalates, polybutylene therephthalates, other polymeric terephthalates, and maleic anhydride-grafted versions of the polymers listed herein.

LSZH materials also do not contain halogens, such as chlorine, and in one or more embodiments, the LSZH material includes a polymer matrix, such as a polymer matrix selected from the list provided above in relation to the FRNC material. Further, in one or more embodiments, the LSZH material may include an intumescent flame retardant package comprising a carbon source, an acid source, and, optionally, a spumific compound. In one or more embodiments, the carbon source is a polyol, such as pentaerythritol, and the acid source is a compound comprising phosphorous, boron, or sulfur, such as ammonium polyphosphate. In embodiments, the acid source, under heating, decomposes and forms an acid that catalyzes the carbon source to carbonize and solidify through cross-linking reactions, forming a non-combustible char layer. In embodiments where included, the spumific compound is a compound that forms gases when heated, which expands the char layer to create a char foam that further insulates the remaining polymer from fire and heat. An example of a spumific compound suitable for use in the LSZH material is melamine or derivatives thereof. In one or more embodiments, the flame retardant package may also include other flame retardant additives, such as ATH and MDH. In one or more embodiments, the total flame retardant package comprises from 5% to 60% by weight of the LSZH material.

In the embodiment depicted, the central bore 18 includes a plurality of buffer tubes 20 stranded around a central strength member 22. In one or more embodiments, the central strength member 22 comprises a central rod 24, such as a glass-reinforced plastic rod or a steel wire, and a polymeric upjacket 26. In one or more embodiments, the buffer tubes 20 are stranded around the central strength member 22 in a helical winding or an SZ winding. In one or more embodiments, the optical fiber cable 10 includes from two to ten buffer tubes 20, in particular five or six buffer tubes 20, stranded around the central strength member 22.

The buffer tubes 20 each have an inner buffer tube surface 28 and an outer buffer tube surface 30. Each inner buffer tube surface 28 defines a buffer tube bore 32 of each buffer tube 20. Disposed within each buffer tube bore 32 are one or more optical fibers 34. In one or more embodiments, the optical fibers 34 are disposed within the buffer tube bores 32 in a loose tube configuration. In one or more other embodiments, the optical fibers 34 are arranged in one or more ribbons within the buffer tube bores 32.

In one or more embodiments, the buffer tubes 20 comprise a polymeric material. For example, current versions of buffer tubes 20 comprise a polypropylene, a polyethylene, a polyamide, a polyvinyl chloride, or a polybutylene terephthalate (PBT) layered on a polycarbonate (PC). However, in other embodiments, the buffer tubes 20 may be made of another polymeric material or a blend of polymeric materials, such as those listed above with respect to the cable jacket 12, amongst other possibilities. Further, in one or more embodiments, the buffer tubes 20 may be made of an FRNC or LSZH material as described above. Similarly, in one or more embodiments, the polymeric upjacket 26 of the central strength member 22 may comprise an FRNC material, an LSZH material, a polypropylene, a polyethylene, a polyamide, a polyvinyl chloride, or one or a blend of the polymeric matrix materials listed above with respect to the cable jacket 12, amongst other possibilities.

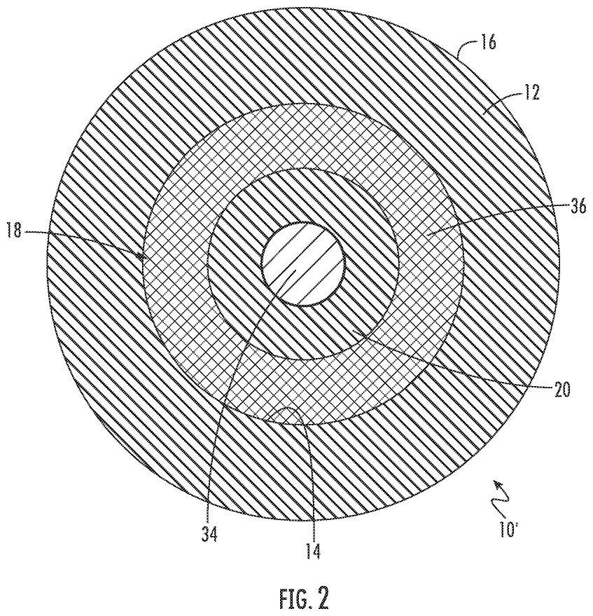

FIG. 2 depicts another embodiment of an optical fiber cable 10′. As with the previous embodiment, the optical fiber cable 10′ includes a cable jacket 12 having a jacket inner surface 14 and a jacket outer surface 16. In one or more embodiments, the jacket outer surface 16 defines an outermost surface of the optical fiber cable 10′, but in one or more other embodiments as will be discussed below, the jacket outer surface 16 may be coated with a flame retardant coating in which case the flame retardant coating would be the outermost surface of the optical fiber cable 10. The jacket inner surface 14 defines a central bore 18. Disposed within the central bore 18 is a buffer tube 20. In the embodiment depicted, a single optical fiber 34 is disposed within the buffer tube 20 in a tight-buffered configuration. However, in other embodiments, the buffer tube 20 includes more than one optical fiber 34 in a loose tube configuration.

In one or more embodiments, the optical fiber cable 10′ includes a layer of strengthening yarns 36 disposed between the buffer tube 20 and the cable jacket 12. In such embodiments, the strengthening yarns 36 may be, for example, aramid yarns.

The embodiments of the optical fiber cables 10, 10′ described herein are merely illustrative. Other optical fiber cable configurations are possible and within the scope of the present disclosure. The embodiments of the optical fiber cables 10, 10′ described herein provide context for cable components on which a flame retardant coating can be applied using layer-by-layer (LBL) coating techniques. For example, the LBL flame retardant coating can be applied to one or more of the cable jacket 12, the buffer tubes 22, and the upjacket 26. In one or more other embodiments, the LBL flame retardant coating may be applied to other cable components, such as binders, wraps, films, etc., that have a high specific surface area.

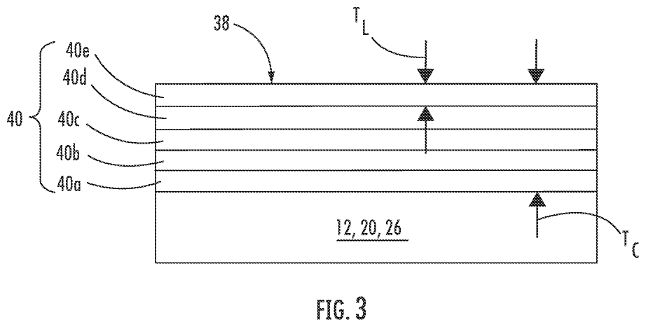

FIG. 3 depicts an example of an LBL flame retardant coating 38. As can be seen in FIG. 3, the LBL flame retardant coating 38 is comprised of one or more layers 40 of flame retardant material. In one or more embodiments, the layers 40 are monolayers, bilayers, trilayers, or quadlayers of flame retardant material. As will be discussed more fully below, the flame retardant material of the LBL flame retardant coating 38 is applied by alternatingly applying polycation and polyanion solutions or suspensions that form a single material (monolayer) or a composite of two or more materials (bilayer, trilayer, or quadlayer). For example, a layer may take the form of a single flame retardant polymer which is applied by depositing, e.g., a cationic portion of the polymer followed by an anionic portion of the polymer which combine to form the desired polymer. In another example, two different materials may be deposited such that the two different materials arrange themselves into discrete sublayers, i.e., bilayers. In one or more embodiments, the number of layers 40 in the LBL flame retardant coating 38 is from one to twenty, in particular from five to ten. In the embodiment of FIG. 3, the number of layers 40a-40e is five.

As shown in FIG. 3, the LBL flame retardant coating 38 has a thickness T_{C}. In embodiments, the thickness T_{C} of the LBL flame retardant coating 38 is at least 0.05 μm, at least 0.1 μm, at least 0.5 μm, or at least 1 μm. In one or more embodiments, the thickness T_{c} of the LBL flame retardant coating 38 is up to 2 μm. Each layer 40 has a thickness T_{L}. In embodiments, the thickness T_{L} of each layer 40 is at least 10 nm, at least 20 nm, at least 30 nm, at least 40 nm, or at least 50 nm. In one or more embodiments, the thickness T_{L} of each layer 40 may be up to 100 nm.

In one or more embodiments, the LBL flame retardant coating 38 comprises layers 40 of various flame retardant materials. In one or more embodiments, the LBL flame retardant coating 38 includes at least one layer 40 comprised of a polymer including silicon, phosphorous, nitrogen, or a combination thereof. In such embodiments, the polymer may be a siloxane, a polyhedral oligomeric silsesquioxanes (POSS), a chitosan, a poly(ethyleneimine), branched poly(ethyleneimine), polyphosphoric acid, poly(allylamine hydrochloride), sodium hexametaphosphate, phytic acid, poly(sodium phosphate), ammonium polyphosphate, DNA, phosphorylated cellulose, oligoallylamine, phosphorylated oligoallylamine, chitin, phosphorylated chitin, nitrogen-modified silane hybrids (SiN), polyhexamethylene guandidine phosphate (PHMGP), phosphorylated polyvinyl alcohol, sodium polyborate, polyacrylic acid, polyacrylamide modified with N-2-(5,5-dimethyl-1,3,2-dioxaphosphinyl-2-ylamino)-ethylacetamide-2-propenyl acid (DPEPA), polyacrylamide modified with N-(5,5-dimethyl-1,3,2-dioxaphosphinyl-2-yl)-acrylamide (DPAA), poly(diallyldimethylammonium chloride) (PDDA), and poly(vinylphosphonic acid), amongst others. In one or more embodiments, the LBL flame retardant coating 38 includes at least one layer 40 formed from electrically charged particles or platelets. In such embodiments, the electrically charged particles or platelets may be a clay, an oxide particle, a metal particle, or a carbon structure. For example, the electrically charged particles or platelets may be a montmorillonite, a graphene oxide, silver nanoparticles, alumina nanoparticles, zirconiumphosphate, laponite, colloidal silica, kaolin, and carbon nanotubes, amongst others.

Example combinations of polymers or polymers and charged particles that can be combined in bi-, tri-, or quad- layers include: chitosan and polyphosphoric acid; branched poly(ethyleneimine) and laponite; branched poly(ethyleneimine) and montmorillonite; POSS⁺ and POSS⁻; branched poly(ethyleneimine) and colloidal silica, poly(allylamine hydrochloride) and sodium hexametaphosphate; chitosan and phytic acid; PDDA and silver nanoparticles; poly(ethyleneimine) and ammonium polyphosphate; chitosan and DNA; branched poly(ethyleneimine), urea, and kaolin; nitrogen-modified silane hybrids and phytic acid; chitosan and poly(vinylphosphonic acid); chitosan and phosphorylated cellulose; PHMGP and sodium borate; chitosan and sodium hexametaphosphate; PDDA, polyacrylic acid, PDDA, and ammonium polyphosphate, and PDDA, polyacrylic acid, PDDA, and DNA, amongst other possible combinations.

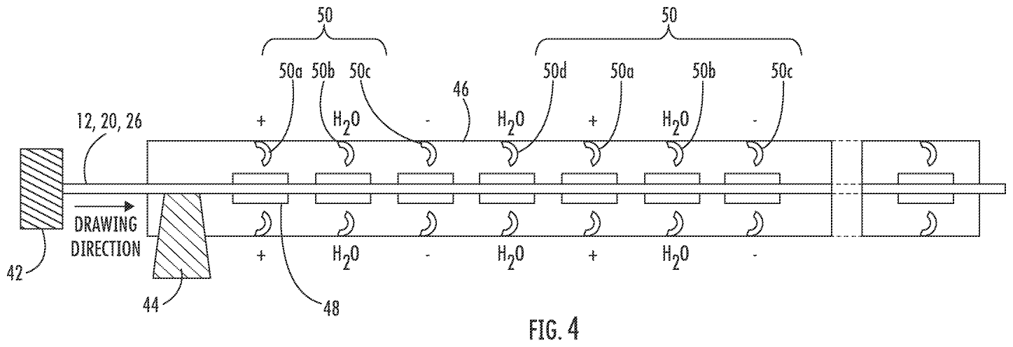

Having described the LBL flame retardant coating 38 and the structure of example embodiments of optical fiber cables 10, 10′, a method and system for applying the LBL flame retardant coating 38 is described in relation to FIG. 4. In the method and system, a polymeric cable component, such as an upjacket 26, a buffer tube 20, or a cable jacket 12, is extruded from an extruder crosshead 42. Upon exiting the extruder crosshead 42, the outer surface of the polymeric cable component may be activated using a surface activating element 44. In one or more embodiments, the surface activating element 44 utilizes plasma, a polyelectrolyte spray, an acid etchant, a flame, or corona discharge, among other possibilities, to create functional groups on the surface of the polymeric cable component.

As shown in FIG. 4, the polymeric cable component is extruded into a cooling trough 46. Surface activation may take place before or after entering the cooling trough 46. Within the cooling trough 46 are a plurality of cooling trays 48 with spray nozzles 50. The spray nozzles 50 are arranged in a repeating sequence of polycation spray 50a, water spray 50b, polyanion spray 50c, and water spray 50d. The outer surface of the polymeric cable component may have negatively charged surface functional groups, or the surface activation element 44 may be used to provide negatively charged surface functional groups as mentioned above. These functional groups react with the polycations applied by the polycation spray nozzle 50a. Excess polycation spray is removed at the water spray nozzle 50b, and then the polyanion spray from the polyanion spray nozzle 50c reacts with the positively charged polycations deposited onto the surface of the polymeric cable component. The spray nozzle 50d rinses excess polyanion spray from the surface of the polymeric cable component.

Depending on the type of LBL flame retardant coating 38, passing through a sequence of spray nozzles 50a-50d will deposit one layer (or bilayer) 40 onto the polymeric cable component. For trilayer or quadlayer coatings, the sequence may need to be extended to include additional polycation, polyanion, and water spray nozzles. Advantageously, the cooling trays 48 collect the polycation solution, the polyanion solution, and the water sprayed onto the polymeric cable component such that, when the polymeric cable component passes through the cooling trays 48, there is increased contact with the surface of the polymeric cable component, thereby enhancing the uniformity of the coating on the polymeric cable component. In one or more embodiments, the LBL coating 38 consists of this single layer 40, but in one or more other embodiments, the sequence of spray nozzles 50a-50d may be repeated until the desired number of layers 40 in the LBL flame retardant coating 38 is developed. For example, the sequence of spray nozzles 50a-50d may repeat from two to twenty times, such as at least five times. Thereafter, the polymeric cable component exits the cooling trough 46 and resumes typical cable processing.

Advantageously, the LBL flame retardant coating can be applied as part of a standard cable processing line. That is, an extruded polymeric cable component will typically enter a cooling bath upon exiting the extruder crosshead. Instead of a standard water bath, embodiments of the method disclosed herein utilize polycation and polyanion sprays to build up layers of flame retardant material on the outer surface of the extruded polymeric cable component during cooling. Further, the materials used for cable construction can remain the same, and the dimensions are minimally changed by the addition of the LBL flame retardant coating. Moreover, in certain circumstances, the overall dimensions of the cable component may be reduced because less FRNC or LSZH material is needed to meet relevant flame retardancy standards. For example, a conventional FRNC or LSZH cable jacket may be thicker than is needed in order to provide enough flame retardant material to meet relevant flame retardancy standards, but by using the presently disclosed LBL flame retardant coating, the cable jacket can be made smaller because less FRNC or LSZH material is needed in the cable jacket.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. An optical fiber cable, comprising:
a cable jacket having a jacket inner surface and a jacket outer surface, the jacket inner surface defining a central bore extending along a longitudinal axis of the optical fiber cable;
a buffer tube having an inner buffer tube surface and an outer buffer tube surface, the buffer tube being disposed within the central bore of the cable jacket;
at least one optical fiber disposed within the buffer tube; and
a flame retardant coating comprising at least one layer;
wherein the flame retardant coating is applied to one or both of the jacket outer surface of the cable jacket or the outer buffer tube surface of the buffer tube.

2. The optical fiber cable of claim 1, wherein the flame retardant coating comprises up to 20 layers.

3. The optical fiber cable of claim 1, wherein each layer of the at least one layer comprises a thickness of up to 100 nm.

4. The optical fiber cable of claim 3, wherein the flame retardant coating comprises a thickness of 0.05 μm to 2 μm.

5. The optical fiber cable of claim 1, wherein each layer of the at least one layer comprises a polymer including at least one of silicon, phosphorus, or nitrogen.

6. The optical fiber cable of claim 1, wherein each layer of the at least one layer comprises at least one of a siloxane, a polyhedral oligomeric silsesquioxanes, a chitosan, a poly(ethyleneimine), branched poly(ethyleneimine), polyphosphoric acid, poly(allylamine hydrochloride), sodium hexametaphosphate, phytic acid, poly(sodium phosphate), ammonium polyphosphate, DNA, phosphorylated cellulose, oligoallylamine, phosphorylated oligoallylamine, chitin, phosphorylated chitin, nitrogen-modified silane hybrids, polyhexamethylene guandidine phosphate, phosphorylated polyvinyl alcohol, sodium polyborate, polyacrylic acid, polyacrylamide modified with N-2-(5,5-dimethyl-1,3,2-dioxaphosphinyl-2-ylamino)-ethylacetamide-2-propenyl acid, polyacrylamide modified with N-(5,5-dimethyl-1,3,2-dioxaphosphinyl-2-yl)-acrylamide, poly(diallyldimethylammonium chloride), or poly(vinylphosphonic acid).

7. The optical fiber cable of claim 1, wherein each layer comprises a clay, an oxide particle, a metal particle, or a carbon structure.

8. The optical fiber cable of claim 1, wherein each layer of the at least one layer comprises a bilayer, a trilayer, or a quadlayer of at least two different materials.

9. The optical fiber cable of claim 1, wherein the cable jacket comprises a flame retardant non-corrosive material or a low smoke, zero halogen material.

10. The optical fiber cable of claim 1, further comprising a central strength member disposed within the central bore, wherein the central strength member comprises a central rod and an upjacket surrounding the central rod and wherein the flame retardant coating is applied to the upjacket.

11. A method of applying a flame retardant coating to a polymeric component of an optical fiber cable, the method comprising:
extruding the polymeric component;
spraying the polymeric component with at least one coating sequence comprising a polycation spray, water, a polyanion spray, and water to form at least one layer of the flame retardant coating on an outer surface of the polymeric component.

12. The method of claim 11, further comprising activating the outer surface of the polymeric component after extruding and before the spraying.

13. The method of claim 12, wherein activating the outer surface comprises exposing the outer surface of the polymeric component to plasma, polyelectrolyte spray, etching, flame treatment, or corona discharge.

14. The method of claim 11, wherein the step of spraying is performed in a cooling trough.

15. The method of claim 11, wherein the polymer component is a buffer tube having at least one optical fiber disposed therein.

16. The method of claim 11, wherein the polymer component is a cable jacket extruded around one or more buffer tubes, each of the one or more buffer tubes having at least one optical fiber disposed therein.

17. The method of claim 11, wherein the polymer component is an upjacket surrounding a central rod to form a central strength member.

18. The method of claim 11, wherein the spraying comprises at least five coating sequences to form at least five layers on the outer surface of the polymeric component.

19. The method of claim 11, wherein each layer comprises a polymer including at least one of silicon, phosphorus, or nitrogen.

20. The method of claim 11, wherein each layer comprises at least one of a siloxane, a polyhedral oligomeric silsesquioxanes, a chitosan, a poly(ethyleneimine), branched poly(ethyleneimine), polyphosphoric acid, poly(allylamine hydrochloride), sodium hexametaphosphate, phytic acid, poly(sodium phosphate), ammonium polyphosphate, DNA, phosphorylated cellulose, oligoallylamine, phosphorylated oligoallylamine, chitin, phosphorylated chitin, nitrogen-modified silane hybrids, polyhexamethylene guandidine phosphate, phosphorylated polyvinyl alcohol, sodium polyborate, polyacrylic acid, polyacrylamide modified with N-2-(5,5-dimethyl-1,3,2-dioxaphosphinyl-2-ylamino)-ethylacetamide-2-propenyl acid, polyacrylamide modified with N-(5,5-dimethyl-1,3,2-dioxaphosphinyl-2-yl)-acrylamide, poly(diallyldimethylammonium chloride), or poly(vinylphosphonic acid).
